(19) United States
(12) Patent Application Publication
(10) Pub. No.: US 2002/0009998 A1
(43) Pub. Date: Jan. 24, 2002

(54) Method for radio transmission in a cellular mobile radio communications network with a hierarchical radio cell structure

(75) Inventor: Jan-Hinnerk Reemtsma, Bonn (DE)

Correspondence Address: SUGHRUE, MION, ZINN, MACPEAK & SEAS, PLLC, 2100 Pennsylvania Avenue, N.W., Washington, DC, 20037-3213, US

(73) Assignee: ALCATEL

(21) Appl. No.: 09/895,265

(22) Filed: Jul. 2, 2001

(30) Foreign Application Priority Data
Jul. 20, 2000 (DE) 100 35 701.6

(51) Int. Cl. H04B 17/00

(52) U.S. Cl. 455/449; 455/450; 455/466; 455/67.1

(57) ABSTRACT

The invention concerns a method for radio transmission in a cellular mobile radio communications network (1). The mobile radio communications network (1) has a hierarchical radio cell structure with small radio cells (2) and with at least one larger radio cell (3) superposed on the small radio cells (2). In order to render possible real-time radio transmission, particularly real-time data transmission, in a mobile radio communications network (1) with a hierarchical radio cell structure and to improve the transmission quality, it is proposed to execute a real-time radio transmission via the at least one superposed larger radio cell (3). A non-real-time data transmission is preferably executed via a smaller radio cell (2). For the purpose of further improving the transmission quality, particularly for the purpose of reducing interfering signals, it is proposed to interrupt the data transmission in the case of a non-real-time data transmission until a measured interfering signal is below a predefinable interference threshold.

### DESCRIPTION

The present invention concerns a method for radio transmission in a cellular mobile radio communications network. The mobile radio communications network has a hierarchical radio cell structure with small radio cells and with at least one larger radio cell superposed on the small radio cells.

The invention also concerns a cellular mobile radio communications network having a hierarchical radio cell structure. The hierarchical radio cell structure comprises small radio cells and at least one larger radio cell superposed on the small radio cells.

Furthermore, the present invention concerns a device for controlling a radio cell cluster consisting of several radio cells of a cellular mobile radio communications network. The mobile radio communications network has a hierarchical radio cell structure with small radio cells and with at least one larger radio cell superposed on the small radio cells.

Mobile radio communications networks with devices for controlling a radio cell cluster of the type initially stated are known from the prior art. A mobile radio communications network can be subdivided into several levels, different components of the mobile radio communications network being located on the individual levels.

On the lowest level of the radio communications network are user terminals (so-called user equipment, UE) in the form of, for example, mobile radio telephones. Base stations are located on the level above. The mobile radio communications network is subdivided geographically into a plurality of radio cells. At least one base station is located in each radio cell. In a mobile radio communications network which operates according to the Universal Mobile Telecommunications System (UMTS) standard, the base stations are designated as node B. The base stations control both the setup of a radio transmission connection to the terminals and the connection tear-down and coordinate the connection to several terminals within a radio cell. The radio transmission connection can be constituted as a permanent connection for the transfer of so-called circuit switched data or as a virtual connection for the transfer of so-called packet switched data. The signals transmitted via the radio transmission connection are digital speech or data signals. Non-real-time data signals are preferably transmitted by packet switching.

Located on the next higher level are devices for controlling a radio cell cluster. Such a device is assigned in each case to several base stations. In the UMTS standard, such a device is designated as a Radio Network Controller (RNC). The device controls, for example, the radio resources (so-called Radio Resource Management) or the power resources (Terrestrial Resource Management) of a radio cell cluster. In particular, the device is responsible for passing on a radio transmission connection from one radio cell to another radio cell (so-called handover) or, in the UMTS standard, for connecting a terminal to at least two base stations (so-called Macro Diversity Mode).

On the highest level, there is at least one relay installation, assigned to the fixed network (core network), which is superordinate over the devices for controlling a radio cell cluster. A radio transmission connection from a mobile terminal to a fixed-network user terminal is established through this relay installation.

Packet switched radio transmission, for example via the Internet Protocol (IP), is assuming increasing importance. Examples of this are the third-generation UMTS standard or methods of radio transmission according to so-called EDGE (Enhanced Data Rates for GSM Evolution) or the so-called GPRS (General Packet Radio Services). The increased use of packet switched data transmissions means an increase in non-real-time services, the radio transmission of which is not very time-critical. Major problems, however, are associated with real-time radio transmissions. This applies particularly if a handover is to be executed between two radio cells. In conventional mobile radio communications networks, the setup of a new radio transmission connection can take more than one second. A handover can take up to seven seconds, which is by far too long for real-time radio transmissions.

Known from the prior art are mobile radio communications networks with a hierarchical radio cell structure which have smaller radio cells (so-called micro cells or pico cells) and larger radio cells (overlay cells) superposed on them.

The object of the present invention is to render possible real-time radio transmission, particularly real-time data transmission, in a mobile radio communications network with a hierarchical radio cell structure and to improve the transmission quality.

For the purpose of achieving this object, the invention, proceeding from the method of the type initially stated, proposes that a real-time radio transmission be executed via the at least one superposed larger radio cell.

The use of real-time radio transmission, i.e., radio transmission of real-time services via the larger radio cells of the mobile radio communications network, can decisively reduce the number of necessary handovers in moving a mobile radio communications user on a determinate path within the mobile radio communications network. This results in a substantially improved transmission quality for real-time services such as, for example, telephone services or also for packet switched data services. The method according to the invention renders possible voice-over-IP and other real-time applications in mobile radio communications networks. Further advantages of the present invention are the simplicity of realization of the method and the fact that its realization does not necessitate any changes whatsoever in the mobile radio communications network level with the base stations.

According to an advantageous development of the present invention, it is proposed that a non-real-time data transmission be executed via a smaller radio cell. Non-real-time data transmission connections can be used, for example, for short messages (e.g. Short Message Service, SMS) or files and suchlike, or the Wireless Application Protocol (WAP) can be used, for example, for accessing the Internet.

According to a preferred embodiment of the present invention, it is proposed that a radio transmission connection be set up via that radio cell (so-called call setup) or a radio transmission connection be passed on (handover) from a radio cell to a radio cell selected according to whether or not the radio transmission is to be executed in real time. In the case of the prior art, an appropriate radio cell for the radio transmission connection in the case of a call setup or a handover is selected primarily according to criteria such as the usage of the radio cells or the required transmission power. According to the invention, a further criterion added for the selection of an appropriate radio cell is the type of the radio transmission connection, namely, whether or not the radio transmission is to be executed in real time.

According to another advantageous development of the present invention, it is proposed that, in the case of a non-real-time radio transmission such as, for example, GPRS, the radio transmission be interrupted until a measured interfering signal is below a predefinable interference threshold. In a mobile radio communications network, one user terminal may cause interference to one or more other terminals in the same radio cell or adjacent radio cells. This can occur, for example, if the interfering terminal transmits with a high transmission power or prompts a base station, in turn, to transmit with a high transmission power. The proposed method according to the development can minimize this type of interfering signal in the case of a non-real-time data transmission such as, for example, GPRS or EDGE. The method proposed in this development is applied particularly in the case of non-real-time data transmissions. It is also conceivable, however, for this method to be applied in real-time radio transmissions with a high mean transmission power (e.g. GERAN, GSM EDGE Radio Access Network, an enhanced EDGE transmission), for example, in the case of user terminals which are located far away from a base station or are in a radio communications gap. The proposed method is particularly suitable for mobile radio communications networks which transmit data according to the Code Division Multiple Access (CDMA) method, such as UMTS for example, since in such networks mutually interfering signals between terminals can occur in the case of high-power radio transmission. The method described is particularly advantageous as a development of the method according to the invention, in which a real-time radio transmission is executed via the large radio cells of a cellular mobile radio communications network with a hierarchical radio cell structure. The method according to this development has the advantages described—reduction of mutually interfering signals between the terminals—including in the case of mobile radio communications networks in which the radio transmission is not packet switched and in which a real-time radio transmission is not executed exclusively via the large radio cells.

According to a further preferred embodiment of the present invention, it is proposed that the method be realized in a Medium Access Control (MAC) layer of a device for controlling a radio cell cluster, the interference being measured and the data transmission interrupted, for the data which is not to be transmitted in real time, if the interference exceeds the predefinable interference threshold. The proposed method is thus realized through a change in the Medium Access Control (MAC) layer of a device for controlling a radio cell cluster (e.g., RNC in the case of UMTS). As soon as the MAC layer receives a data package for transmission, the MAC layer checks the status of an interfering signal. If the status is “critical”, the data transmission is interrupted.

Advantageously, the interfering signal is measured periodically and the data transmission resumed, if the interference falls below the predefinable interference threshold. The data transmission is thus resumed as soon as the status of the interfering signal changes to “non-critical”.

The data transmission is preferably interrupted only in the case of those non-real-time data transmissions whose mean transmission power is above a predefinable power threshold. Since an interfering signal can also have causes other than data transmission with a high transmission power and the method according to the invention primarily remedies interference caused in such a way, this embodiment of the invention avoids unnecessary interruption of the data transmission.

As a further means of achieving the object of the present invention, it is proposed, proceeding from the cellular mobile radio communications network of the type initially stated, that the mobile radio communications network have means for the selection of a radio cell for the purpose of setting up a radio transmission connection (call setup) or for the purpose of passing on a radio transmission connection from another radio cell (handover). The selection is made according to whether or not the radio transmission is to be executed in real time.

According to an advantageous development of the present invention, it is proposed that the means for the selection of a radio cell for a real-time radio transmission select a larger radio cell.

It is furthermore proposed that the means for the selection of a radio cell of a non-real-time data transmission select a smaller radio cell.

According to a preferred embodiment of the present invention, it is proposed that the mobile radio communications network have means for the execution of a method according to the invention.

As yet a further means of achieving the object of the present invention, it is proposed, proceeding from a device for controlling a radio cell cluster consisting of several radio cells of a cellular mobile radio communications network of the type initially stated, that the device has means for the selection of a radio cell for the purpose of setting up a radio transmission connection (call setup) or for the purpose of passing on a radio transmission connection from another radio cell (handover), according to whether or not the radio transmission is to be executed in real time.

According to an advantageous development of the present invention, it is proposed that the means for the selection of a radio cell for a real-time radio transmission select a larger radio cell. It is furthermore proposed that the means for the selection of a radio cell for a non-real-time data transmission select a smaller radio cell.

As a preferred embodiment of the present invention, it is proposed that the mobile radio communications network has means for executing the method according to the invention.

Of particular importance is the realization of the method according to the invention in the form of a storage element provided for a device for controlling a radio cell cluster consisting of several radio cells of a cellular mobile radio communications network. Stored on the storage element is a program which is capable of being executed on a computing device, in particular, on a microprocessor, and is suitable for execution of the method according to the invention. In this case, therefore, the invention is realized through a program stored on the storage element, so that this storage element provided with the program constitutes the invention in the same way as the method for the execution of which the program is suitable. In particular, an electrical storage medium, e.g. a read-only memory, random-access memory or flash memory, can be used as a storage element.

Further features, application possibilities and advantages of the invention are disclosed by the following description of embodiment examples of the invention, which are represented in the drawing. All described or represented features, whether individually or in combination, constitute the subject-matter of the invention, irrespective of their combination in the claims or their reference association, and irrespective of their wording or representation in the description or in the drawing respectively, wherein:

FIG. 1 shows a schematic illustration of a preferred embodiment of a cellular mobile radio communications network according to the invention; and

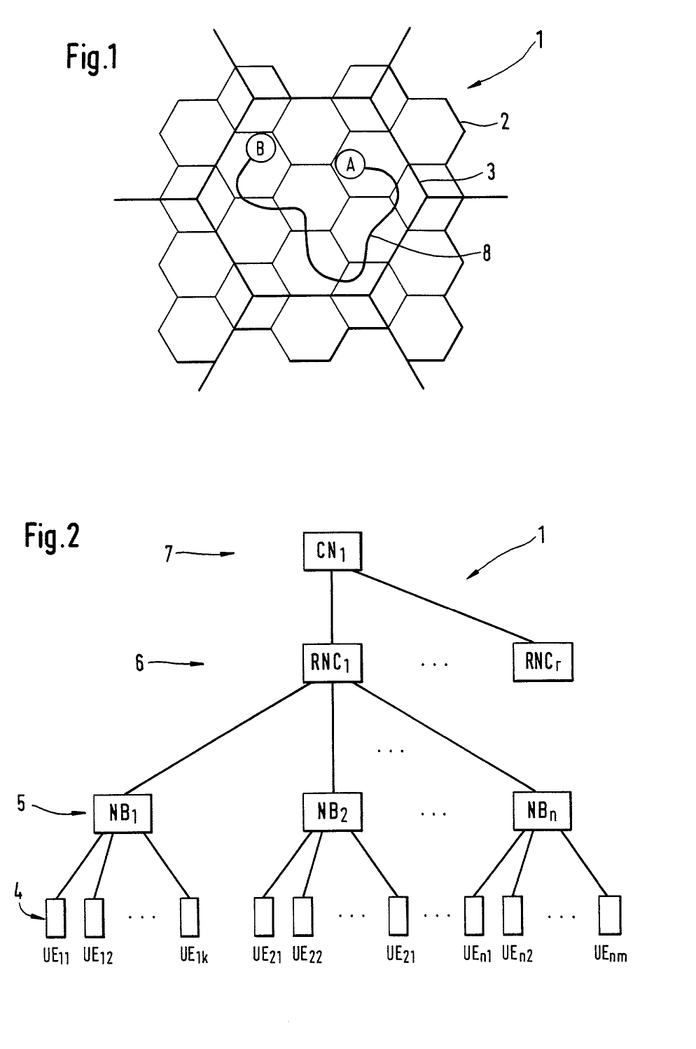

FIG. 2 shows a further schematic illustration of the mobile radio communications network from FIG. 1;

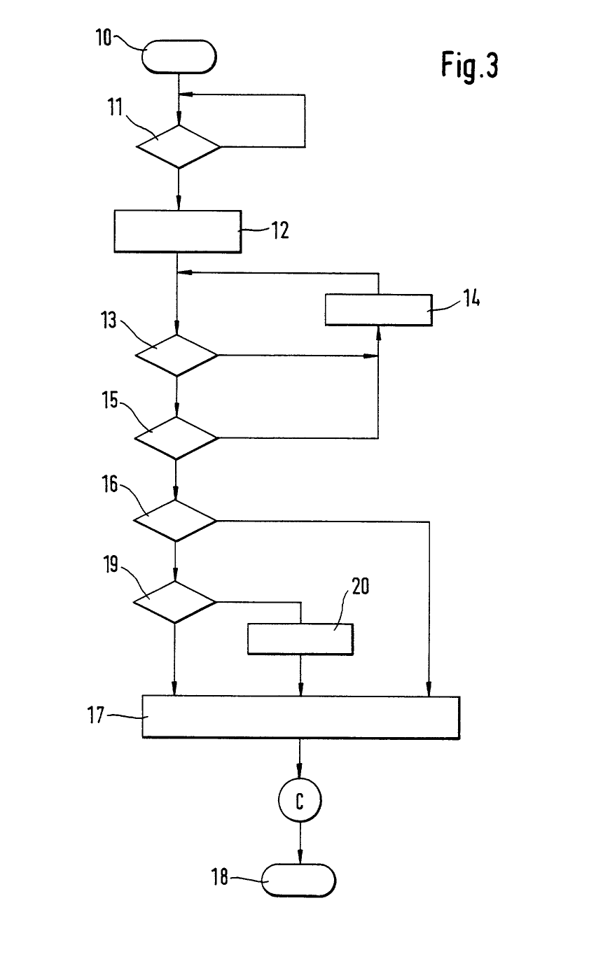

FIG. 3 shows a flow diagram of a preferred embodiment of a method according to the invention;

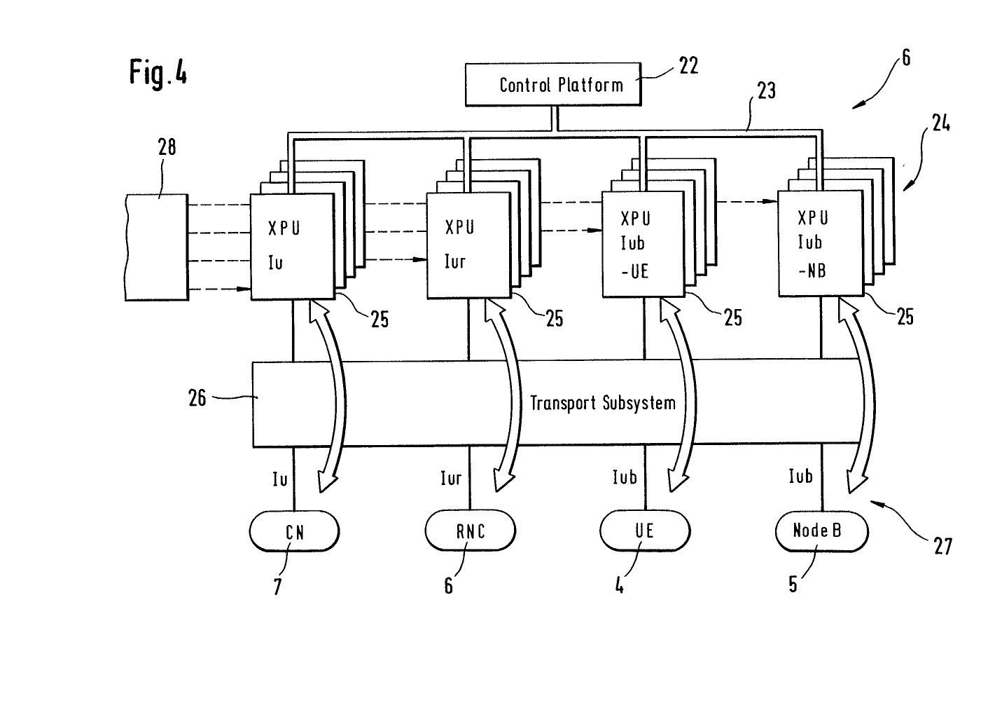

FIG. 4 shows a device according to the invention for controlling a radio cell cluster of a cellular mobile radio communications network; and

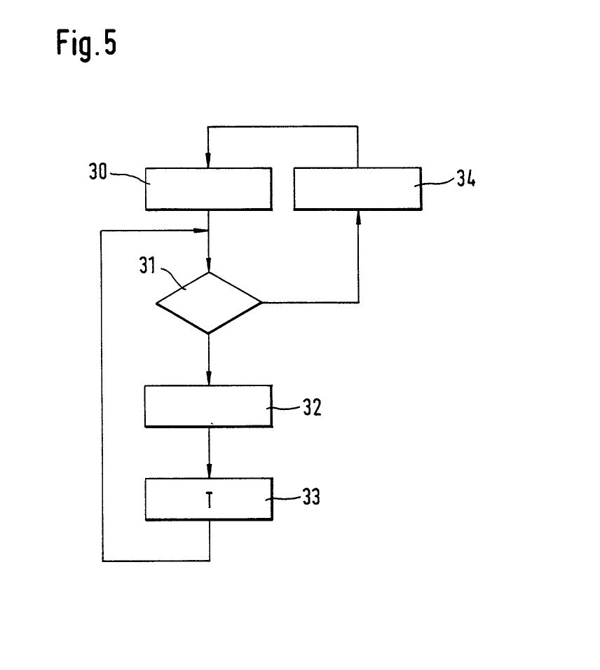

FIG. 5 shows a flow diagram of a development of the method according to the invention for reducing interfering signals.

In FIG. 1, a cellular mobile radio communications network 1 according to the invention, in the form of a Universal Mobile Telecommunications System (UMTS) is denoted in its entirety by the reference 1. The mobile radio communications network 1 has a hierarchical radio cell structure which comprises smaller radio cells 2 (so-called micro cells or pico cells) and larger radio cells 3 (overlay cells) superposed on them.

The mobile radio communications network 1 is subdivided into several levels (cf. FIG. 2), different components of the mobile radio communications network 1 being located on the individual levels. On the lowest level of the radio communications network are user terminals 4 (so-called user equipment, UE) in the form of, for example, mobile radio telephones. Base stations 5 are located on the level above. The mobile radio communications network 1 is subdivided geographically into a plurality of radio cells 2, 3. At least one base station 5 is located in each radio cell 2, 3. In the UMTS standard, the base stations 5 are designated as node B (NB). The base stations 5 control both the setup of a radio transmission connection to the terminals 4 and the connection tear-down and coordinate the connection to several terminals 4 with a radio cell 2, 3. The radio transmission connection is used, for example, for telephony or, also, for the transfer of so-called packet switched data. The packet switched data transmission is executed, for example, according to the Internet Protocol (IP). A packet switched data transmission is executed, for example, according to the third-generation UMTS standard or methods such as EDGE (Enhanced Data Rates for GSM Evolution) or GPRS (General Packet Radio Services).

Located on the next higher level are devices 6 for controlling a radio cell cluster. In the UMTS standard, the devices 6 are also designated as Radio Network Controllers (RNC). Such a device 6 is assigned in each case to several base stations 5. The dimensions of the radio cell clusters can be designed to correspond to the large radio cells 3 or, alternatively, can differ from the dimensions of the latter. The device 6 controls, for example, the radio resources (so-called Radio Resource Management) or the power resources (Terrestrial Resource Management) of a radio cell cluster. In particular, the device 6 is responsible for passing on a radio transmission connection from one radio cell 2, 3 to another radio cell 2, 3 (so-called handover) or, in the UMTS standard, for connecting a terminal 4 to at least two base stations 5 (so-called Macro Diversity Mode).

On the highest level, there is at least one relay installation 7, assigned to the fixed network (the so-called core network), which is superordinate over the devices 6 for controlling a radio cell cluster. A radio transmission connection from a terminal 4 to a fixed-network user terminal is established through this relay installation 7.

Problems are increasingly caused by radio transmission for real-time services, particularly packet switched data transmission. This applies particularly if a handover is to be executed between two radio cells 2, 3. In the case of GPRS, the setup of a new radio transmission connection can take more than one second. A handover can take up to seven seconds, which is by far too long for real-time radio transmissions.

It is therefore proposed, according to the invention, to execute the real-time radio transmissions via a larger radio cell 3, in order thus to reduce the number of necessary handovers. In addition, the invention results in a reduction of interruptions in the case of real-time services (service interrupts). In the example from FIG. 1, six handovers would have to be executed in the case of a radio transmission connection to a user terminal 4 via the small radio cells 2 on the path 8 from A to B. By contrast, in the case of a radio transmission connection via the large radio cell 3, there is no need for a single handover, resulting in a substantial improvement in the quality of the radio connection. In addition, real-time requirements in respect of the radio transmission connection can be fulfilled with substantially greater reliability. For this reason, the method according to the invention is particularly suitable for voice-over-IP or other real-time applications in mobile radio communications networks.

The method according to the invention is described more fully below with reference to FIG. 3. It starts in a function block 10. The user terminal 4 is either in a switched-off state or in a call-active state. A query block 11 then checks whether a radio transmission connection to a radio cell 2 is to be set up. This is the case, for example, for the purpose of setting up a radio transmission connection (call setup) to the radio cell 2 if the terminal 4 is switched off or for the purpose of passing on the active radio transmission connection from another radio cell 2 to the radio cell 2 if the terminal 4 is call-active. If no radio transmission connection to the radio cell 2 is to be set up, the operation branches back to the initial status (terminal 4 switched off or call-active).

If a radio transmission connection to the radio cell 2, 3 is to be set up, however, the radio cell 2, 3 to which a radio transmission connection is to be set up is selected in a function block 12. In the case of the terminal 4 being switched off, this is preferably one of the radio cells 2, 3 in which the terminal 4 is located and, in the case of the terminal 4 being call-active, one of the radio cells 2, 3 into which the terminal 4 is moving. A query block 13 then checks whether the required transmission power can be achieved in the selected radio cell 2, 3. If not, a different radio cell 2, 3 is selected in a function block 14.

If the required transmission power can be achieved in the selected radio cell 2, 3, however, a query block 15 checks whether the selected radio cell 2, 3 has a low usage, i.e., that the usage does not exceed a predefinable usage threshold. If that is not the case, i.e., if the selected radio cell 2, 3 is overloaded, the operation branches back to the function block 14 and a different radio cell 2, 3 is selected. The selection of the radio cell 2, 3 according to the criteria of achievable transmission power and usage is known from the prior art.

Added according to the invention as a further criterion for the selection of the radio cell 2, 3 is a further query by the query block 16, namely, whether the radio transmission is to be executed in real time. If not, the operation branches to function block 17, in which a transmission connection to the selected radio cell 2 is set up. The method according to the invention is ended in function block 18. Prior to ending of the method according to the invention, a method for reducing interfering signals, represented in FIG. 5, can also be executed at the position C.

If a real-time radio transmission is required, however, the query block 19 checks whether a large radio cell 3 of the mobile radio communications network 1 has been selected. If so, the operation can branch directly to the function block 18 and the radio transmission connection to the selected radio cell 3 can be set up. If a small radio cell 2 has been selected, however, a large radio cell 3, superposed on the small radio cell 2, is selected in a function block 20. Only after that stage does the operation branch to the function block 18, and the radio transmission connection to the selected radio cell 3 is set up.

A device 6 according to the invention represented in FIG. 4 is also designated as an RNC (Radio Network Controller). The device 6 controls a radio cell cluster consisting of several radio cells of the Universal Mobile Telecommunications System (UMTS) radio communications network 1 (cf. FIG. 1). The device 6 is subdivided into several levels. The top level is designated as the control platform 22 and comprises an OAM (Operation and Maintenance) server and a Telecom server (neither of which is represented). The control platform 22 is directly connected, for example via an Ethernet connection 23, to a level underneath.

The level underneath is designate as aux subsystem 24 and comprises several processors 25 XPU. Each four processors 25 are combined to form a processor group XPU Iu, XPU Iur, XPU Iub-UE and XPU Iub-NB. The level underneath is designated as transport subsystem 26 and comprises at least one switching element (not represented). The switching element is designed as an Internet Protocol (IP) router or as a Multi-Path Self-Routing (MPSR) switch.

From the switching element, several interfaces 27 Iu, Iur, Iub-UE, Iub-NB branch off to different components of the radio communications network 1. The components of the radio communications network 1 comprise at least one user terminal 4, at least one base station 5, at least one further device 6 for controlling a further radio cell cluster and at least one relay installation 7. The interfaces 27 Iu, Iur, Iub-UE and Iub-NB are connected to the processors 25 XPU via the switching element in the transport subsystem 26.

The device 6 also comprises at least one storage element 28 on which there is stored a program which is capable of being executed on the microprocessors 25. The program is suitable for execution of the method according to the invention. In particular, an electrical storage medium, e.g. a read-only memory, random-access memory or flash memory, can be used as a storage element 28.

In mobile radio communications networks 1, the transmission power for the radio transmission between a terminal 4 and a base station 5 can be varied in order to permit attainment of a determinate transmission quality (e.g., “bit error rate” or “frame error rate”). If a user terminal 4 transmits with a high transmission power or prompts a base station 5, in turn, to transmit with a high transmission power, the terminal 4 may cause interference to one or more other terminals 4 in the same radio cell 2, 3 or in adjacent radio cells 2, 3. This type of interfering signal can be minimized with the method represented in FIG. 5. The method can be executed at the position C as part of the method according to the invention represented in FIG. 3. In the case of the method from FIG. 5, the radio transmission is interrupted until a measured interfering signal is below a predefinable interference threshold. The method is applied particularly in the case of non-real-time data transmissions. It is also conceivable, however, to apply this method in the case of real-time radio transmissions with a high mean transmission power, for example, in the case of user terminals 4 which are located far away from a base station 5 or are in a radio communications gap. The method from FIG. 5 is particularly suitable for mobile radio communications networks 1 which transmit data according to the Code Division Multiple Access (CDMA) method, such as UMTS for example, since in such networks mutually interfering signals between terminals 4 can occur in the case of a high-power radio transmission.

The method from FIG. 5 is realized in a Medium Access Control (MAC) layer of the device 6 for controlling a radio cell cluster. As soon as the MAC layer in function block 30 receives a data package for transmission, a query block 31 of the MAC layer checks the status of an interfering signal. If the status is “critical”, i.e., if the interfering signal exceeds the predefined interference threshold, the data transmission is interrupted in function block 32. A predefinable period of time T is then waited in a function block 33, in order then to branch to the query block 31 and to recheck the status of the interfering signal. If the status of the interfering signal is “non-critical”, i.e., if the interfering signal is below the predefined interference threshold, the data package received in function block 30 is transmitted to function block 34. The operation then branches back to the function block 30 for the receipt of a further data package.

The interfering signal is thus measured periodically and the data transmission resumed if the interference falls below the predefinable interference threshold. The data transmission is resumed as soon as the status of the interfering signal changes to “non-critical”.

1. Method for radio transmission in a cellular mobile radio communications network (1), which has a hierarchical radio cell structure with small radio cells (2) and with at least one larger radio cell (3) superposed on the small radio cells (2), characterized in that a real-time radio transmission is executed via the at least one superposed larger radio cell (3).

2. Method according to claim 1, characterized in that a non-real-time radio transmission is executed via the smaller radio cells (2).

3. Method according to either of claims 1 or 2, characterized in that a radio transmission connection is set up via that radio cell (2, 3) or a radio transmission connection is passed on from a radio cell (2, 3) to a radio cell (2, 3) selected according to whether or not the radio transmission is to be executed in real time.

4. Method according to any one of claims 1 to 3, characterized in that in the case of a non-real-time data transmission, the radio transmission is interrupted until a measured interfering signal is below a predefinable interference threshold.

5. Method according to claim 4, characterized in that the method is realized in a Medium Access Control (MAC) layer of a device for controlling a radio cell cluster, the interfering signal being measured and the data transmission interrupted, for the data which is not to be transmitted in real time, if the interfering signal exceeds the predefinable interference threshold.

6. Method according to claim 5, characterized in that the interference is measured periodically and the data transmission resumed if the interfering signal falls below the predefinable interference threshold.

7. Method according to any one of claims 4 to 6, characterized in that the data transmission is interrupted only in the case of those non-real-time data transmissions whose mean transmission power is above a predefinable power threshold.

8. Cellular mobile radio communications network (1) having a hierarchical radio cell structure, with small radio cells (2) and at least one larger radio cell (3) superposed on the small radio cells (2), characterized in that the mobile radio communications network (1) comprises means (6) for the selection of a radio cell (2, 3) for the purpose of setting up a radio transmission connection or for the purpose of passing on a radio transmission connection from another radio cell (2, 3) according to whether or not the radio transmission is to be executed in real time.

9. Mobile radio communications network according to claim 8, characterized in that the means for the selection of a radio cell for a real-time radio transmission select a larger radio cell.

10. Mobile radio communications network according to either of claims 8 or 9, characterized in that the means for the selection of a radio cell for a non-real-time radio transmission select a smaller radio cell.

11. Device (6) for controlling a radio cell cluster consisting of several radio cells (2, 3) of a cellular mobile radio communications network (1) having a hierarchical radio cell structure with small radio cells (2) and with at least one larger radio cell (3) superposed on the small radio cells (2), characterized in that the device (6) comprises means for the selection of a radio cell (2, 3) for the purpose of setting up a radio transmission connection or for the purpose of passing on a radio transmission connection from another radio cell (2, 3) according to whether or not the radio transmission is to be executed in real time.

12. Device (6) according to claim 11, characterized in that the means for the selection of a radio cell (2, 3) for a real-time radio transmission select a larger radio cell (3).

13. Device (6) according to either of claims 11 or 12, characterized in that the means for the selection of a radio cell (2, 3) for a non-real-time radio transmission select a smaller radio cell (2).
